(19) United States
(12) Patent Application Publication
(10) Pub. No.: US 2026/0349942 A1
(43) Pub. Date: Nov. 5, 2026

(54) MANAGING INTERRUPTS FROM PERIPHERAL DEVICES

(71) Applicant: QUALCOMM Incorporated, San Diego, CA (US)

(72) Inventors: Sagar BAMASHETTI, Chadchan (IN); Narahari TARAKARAM, Bengaluru (IN); Sharath Kumar NAGILLA, Hyderabad (IN); Anji Reddy JONNALA, Guntur (IN); Raghavendra KAKARLA, Anantapur (IN); Alex PARK, San Diego, CA (US)

(21) Appl. No.: 19/194,269

(22) Filed: Apr. 30, 2025

(51) Int. Cl. G06F 13/24

(52) U.S. Cl. CPC G06F 13/24; G06F 2213/24

(57) ABSTRACT

An interrupt controller is disclosed. The interrupt controller may include a monitoring circuit that may track, in a monitoring interval, a frequency of occurrence of one or more interrupts associated with an identifier. In an event that the frequency of occurrence of the one or more interrupts may exceed a threshold value, the monitoring circuit may generate an error signal.

### BACKGROUND

### Field of the Disclosure

The present disclosure relates generally to electronic systems, and, more particularly, to managing interrupts from peripheral devices in electronic systems.

### Description of Related Art

Interrupt controllers are widely employed across various electronic devices, such as Internet of Things (IoT) devices, automotive systems, and similar platforms, to manage interrupts generated by integrated or external peripherals. For example, one or more interrupt controllers may handle interrupts originating from peripheral devices. Upon receiving an interrupt, the interrupt controller identifies a processing core, to handle the interrupt. In some cases, a peripheral device may experience unexpected behavior, which can result in the generation of pseudo or spurious interrupts. If one or more peripheral devices begin generating such pseudo interrupts at a high rate, the interrupt controller may become overloaded, potentially affecting overall system responsiveness and performance.

### SUMMARY

Aspects of the disclosure provide an interrupt controller. The interrupt controller may comprise a monitoring circuit configured to track, in a monitoring interval, a frequency of occurrence of one or more interrupts associated with an identifier, and generate an error signal based on the frequency of occurrence of the one or more interrupts exceeding a threshold value.

In further aspects of the disclosure, a system-on-chip (SoC) is provided. The SoC comprises one or more memories and an interrupt controller coupled to the one or more memories, wherein the interrupt controller comprises an interrupt handling circuit and one or more monitoring circuits coupled to the interrupt handling circuit. The interrupt handling circuit may be configured to receive one or more interrupts from one or more peripheral devices. A monitoring circuit of the one or more monitoring circuits may be configured to track, in a monitoring interval, a frequency of occurrence of the one or more interrupts associated with an identifier and generate an error signal based on the frequency of occurrence of the one or more interrupts exceeding a threshold value.

In further aspects of the disclosure, a method may be provided. The method may be executed at an interrupt controller. The method may comprise tracking, in a monitoring interval, a frequency of occurrence of one or more interrupts associated with an identifier and generating an error signal based on the frequency of occurrence of the one or more interrupts exceeding a threshold value.

### BRIEF DESCRIPTION OF THE DRAWINGS

Various aspects of the present disclosure are illustrated by way of example, and not limited by the appended figures, in which like references indicate similar elements:

FIG. 1 is a diagram that illustrates a system, in accordance with certain aspects of the present disclosure;

FIG. 2 is a diagram that illustrates a system-on-chip (SoC) of the system of FIG. 1, in accordance with certain aspects of the present disclosure;

FIGS. 3A and 3B are diagrams that illustrate a monitoring table of the SoC of FIG. 2, in accordance with certain aspects of the present disclosure;

FIG. 4 is a diagram that illustrates a high-level flowchart of a method (e.g., a process) executed by a monitoring circuit of an interrupt controller of the system of FIG. 1, in accordance with an exemplary aspect of the present disclosure;

FIG. 5 is a diagram that illustrates a flowchart of a method (e.g., a process) executed at a register bank of the interrupt controller of the system of FIG. 1, in accordance with an exemplary aspect of the present disclosure;

FIG. 6 is a diagram that illustrates a flowchart of a method (e.g., a process) executed by the monitoring circuit of the interrupt controller of the system of FIG. 1, in accordance with an exemplary aspect of the present disclosure; and

FIGS. 7A and 7B are diagrams that illustrate a detailed flowchart of a method (e.g., a process) executed by the interrupt controller of the system of FIG. 1, in accordance with an exemplary aspect of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form to avoid obscuring such concepts.

Several aspects of the disclosure will now be presented with reference to an apparatus and method. Such apparatus and method will be described in the following detailed description and illustrated in the accompanying drawings by various blocks, modules, components, circuits, steps, processes, or the like (collectively referred to as “elements”).

Accordingly, in one or more aspects, the functions described by elements of the disclosure may be implemented in hardware, software, or any combination thereof depending upon the particular application and design constraints imposed on the overall apparatus. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

At least one of a host processor, a processing core, a processor, or any portion of any of such components, or any combination of such components may be implemented as a “processing system” that may include one or more processors. Examples of processors include microprocessors, microcontrollers, graphics processing units, central processing units, application processors, digital signal processors, reduced instruction set computing processors, systems on a chip, baseband processors, field programmable gate arrays, programmable logic devices, state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Internet of Things (IoT) systems, automobiles, and communication devices include various components that communicate with each other to achieve desired operations of the systems/devices. The components may include peripheral devices, interrupt controllers, memories, processing cores, or the like. An interrupt controller may be implemented in such systems to manage interrupts from various peripheral devices. A peripheral device may generate an interrupt to alert a processor to execute operations associated with the interrupt. In one scenario, the interrupts may be message-based interrupts such as locality-specific peripheral interrupts (LPIs). LPIs allow for flexible and scalable handling of interrupts in systems with a large number of peripheral devices. As LPIs are managed by the interrupt controller via memory registers, the usage of LPIs may eliminate a need for implementing additional physical wiring in the systems.

A peripheral device may encounter operational faults due to aging, wear and tear, or the like, or malicious attacks, causing the peripheral device to turn faulty or defective. A faulty peripheral device may generate pseudo LPIs (e.g., erroneous or pseudo interrupts) at a high rate, which may eventually increase a processing load on the system. As a result, processors that service the pseudo LPIs may be diverted from performing critical tasks, potentially leading to a Denial of Service (DoS) condition. Additionally, the excessive generation of pseudo interrupts can consume a substantial portion of processing resources of the system, leading to degraded performance or even system failure, as processor time is spent servicing the pseudo LPIs instead of executing regular workloads. In addition, a faulty peripheral device generating high-priority pseudo LPIs may cause priority inversion, resulting in delayed execution of other critical LPIs and further leading to system instability or operational failure. Moreover, the challenge of diagnosing pseudo interrupts may introduce additional operational overhead in managing interrupt handling.

Certain aspects disclosed herein provide methods, circuits and systems that are adapted to manage interrupts from peripheral devices. For example, the system may include a monitoring circuit that may track a frequency of occurrence of interrupts generated by peripheral devices in a monitoring interval. The monitoring circuit may generate an error signal if the frequency of a specific interrupt from one or more peripheral devices or if the frequency of interrupts from a specific peripheral device exceeds a threshold interrupt count in a current monitoring interval.

The monitoring circuit described in the present disclosure may enhance security by mitigating malicious or faulty behavior from defective peripheral devices. For example, the monitoring circuit can prevent a pseudo interrupt from being scheduled to a processor of the system, thus maintaining system integrity. Additionally, by reducing the processing overhead associated with handling pseudo interrupts, the monitoring circuit can improve the overall stability and reliability of the system compared to conventional systems that process such pseudo interrupts.

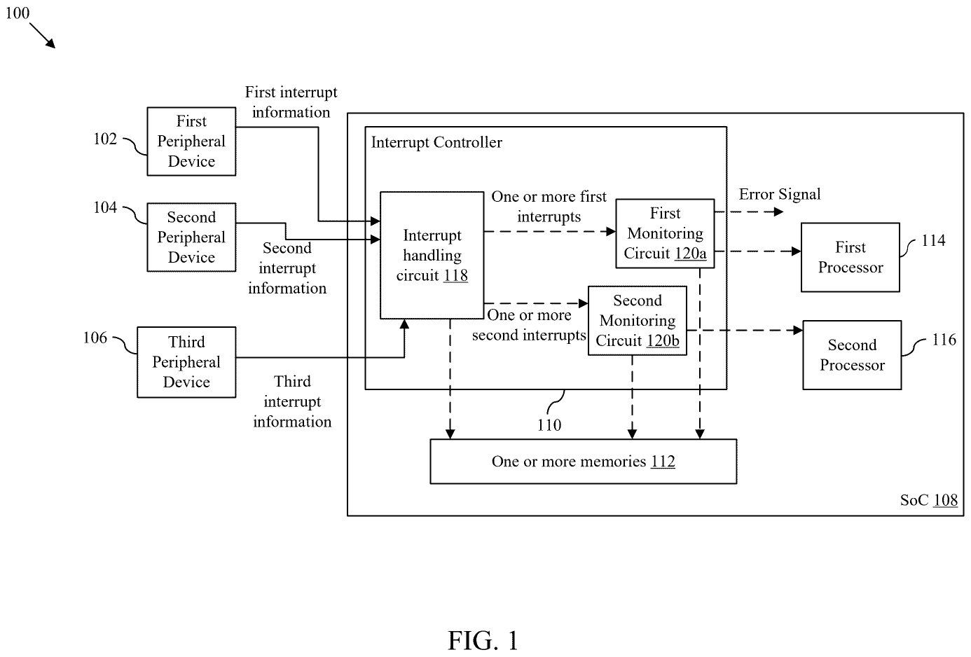

FIG. 1 is a diagram that illustrates a system 100, in accordance with certain aspects of the present disclosure. The system 100 may include one or more peripheral devices, referred to as “peripheral devices 102-106” of which a first peripheral device 102, a second peripheral device 104, and a third peripheral device 106 are shown. The system 100 may further include a system-on-chip (SoC) 108. In certain aspects, the system 100 may be an automotive system, a home automation system, a communication system, or the like. In further aspects, the system 100 may be implemented in robotic systems, healthcare systems, immersive reality systems, or the like. It will be further understood by a person skilled in the art that the system 100 may be implemented in various additional or alternate systems. In further aspects, the system 100 may correspond to a device. Examples of the device may include a cellular phone, a smartphone, a laptop, a notebook, a tablet, a phablet, a personal digital assistant, a satellite radio, a global positioning system device, a smart home device, intelligent lighting, a multimedia device, a video device, a digital audio player, a camera, a game console, an entertainment device, a vehicle component, a wearable computing device (e.g., a smartwatch, a health or fitness tracker, or eyewear), an appliance, a security device, a vending machine, a smart meter, or any other similar functioning device.

The SoC 108 may be a processing chip that may integrate multiple components, which are arranged to facilitate desired functions of the SoC 108. In one aspect, the SoC 108 may include an interrupt controller 110, one or more memories 112, and one or more processors of which a first processor 114 and a second processor 116 are shown.

The peripheral devices 102-106 may generate interrupts that are managed by the SoC 108. In one example, each of the peripheral devices 102-106 may generate more than one interrupt. Each interrupt may further be associated with a corresponding processor of the SoC 108. Further stated, each interrupt may be mapped to one of the first processor 114 or the second processor 116 thereby indicating a processor that can service the corresponding interrupt. Examples of various operations performed to service an interrupt may include initiating data communication between a corresponding peripheral and a processor, communication of alerts or status updates, triggering a secure operation, executing at least one of error recovery, diagnosis, or debug operations, or the like.

In one aspect, the system 100 may be a smart home system. Thus, the peripheral devices 102-106 may include various IoT devices, such as smart thermostats, security cameras, and smart locks that may be coupled to a central hub that includes the SoC 108. In further aspects, the system 100 may be implemented in an autonomous vehicle. Thus, the peripheral devices 102-106 may include multiple sensors, for example, light detection and ranging sensors, cameras, radar, or the like, that may be coupled to a central processing unit, e.g., the SoC 108, in the vehicle. In further aspects, the system 100 may be a communication device and the peripheral devices 102-106 may include a camera, sensors, microphone, or the like.

In one aspect, each of the peripheral devices 102-106 may generate an interrupt in response to a corresponding event and provide the interrupt to the interrupt controller 110 (e.g., by writing interrupt-related information to the interrupt controller 110). The events may be associated with one or more operations in the system 100 and may be indicative of faut recovery, diagnosis, debug, or initiating various operations associated with security, data transfer, or the like. Interrupt-related information may include a device identifier that uniquely identifies a peripheral device, along with one or more event identifiers identifying the event associated with the interrupt. For example, the first peripheral device 102 may generate first interrupts and provide the first interrupts to the interrupt controller 110. Providing the first interrupts to the interrupt controller 110 may include providing first interrupt information, e.g., one or more first event identifiers and a first device identifier of the first peripheral device 102, to the interrupt controller 110. Similarly, the second peripheral device 104 may generate second interrupts and provide one or more second event identifiers and a second device identifier of the second peripheral device 104 as second interrupt information to the interrupt controller 110. Further, the third peripheral device 106 may generate third interrupts and provide one or more third event identifiers and a third device identifier of the third peripheral device 106 as third interrupt information, to the interrupt controller 110.

The interrupt controller 110 may thus be configured to receive the first through third interrupts from the peripheral devices 102-106, respectively. The interrupt controller 110 may be further configured to monitor a frequency of occurrence of each interrupt from the peripheral devices 102-106 as explained in the ongoing description. The interrupt controller 110 may be implemented by way of control registers, status registers, processors, or the like. In one aspect, the interrupt controller 110 may include an interrupt handling circuit 118 and one or more monitoring circuits, referred to as “monitoring circuits 120a and 120b”, that may be coupled to the interrupt handling circuit 118. Each of the monitoring circuits 120a and 120b may be associated with one of the first processor 114 or the second processor 116. In one example, the first monitoring circuit 120a may be associated with the first processor 114 and the second monitoring circuit 120b may be associated with the second processor 116. In one aspect, the interrupt handling circuit 118 may be an interrupt translator and each of the monitoring circuits 120a and 120b may be a redistributor.

The interrupt handling circuit 118 may be configured to receive the first through third interrupts (e.g., device identifiers and event identifiers) from the peripheral devices 102-106, respectively. In one example, the interrupt handling circuit 118 may receive the one or more first event identifiers and the first device identifier from the first peripheral device 102, the one or more second event identifiers and the second device identifier from the second peripheral device 104, and the one or more third event identifiers and the third device identifier from the third peripheral device 106. Further, the interrupt handling circuit 118 may refer to the one or more memories 112 to translate each of the first through third event identifiers into a corresponding interrupt identifier. Further stated, the interrupt handling circuit 118 may be further configured to translate an interrupt event from any of the peripheral devices 102-106 into a corresponding LPI (e.g., generate an LPI).

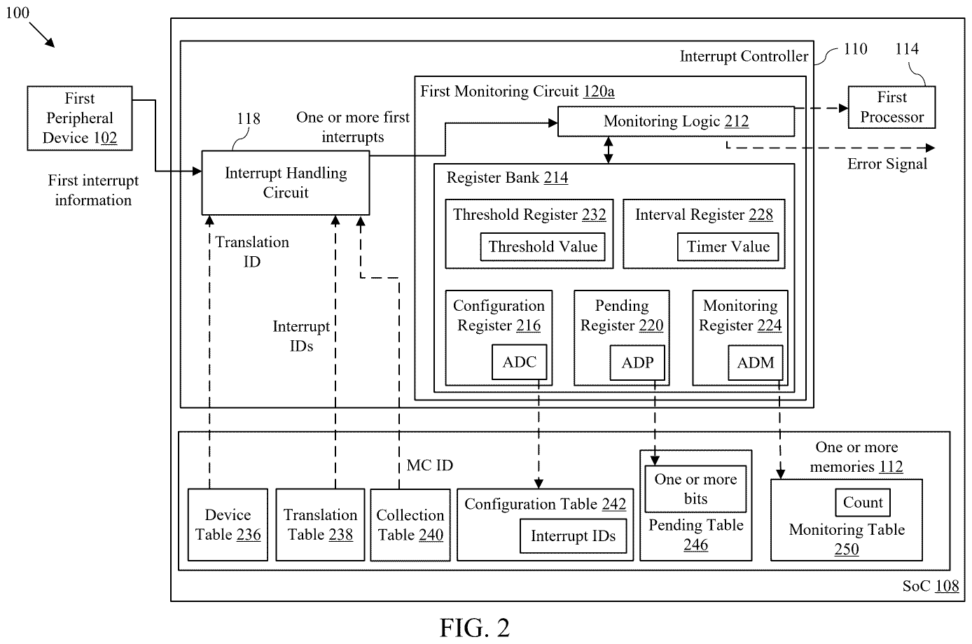

An LPI may be a message-based interrupt. In one example, based on the first event identifiers and the first device identifier, first LPIs may be generated. Further, based on the second event identifiers and the second device identifier, second LPIs may be generated, and based on the third event identifiers and the third device identifier, third LPIs may be generated. The interrupt handling circuit 118 may further identify a target monitoring circuit for each interrupt identifier via the one or more memories 112. Further, the interrupt handling circuit 118 may be configured to provide the translated interrupt (e.g., corresponding LPIs) to the target monitoring circuit. In one example, the interrupt handling circuit 118 may provide one or more first interrupts (e.g., one or more first interrupt identifiers) associated with any of the peripheral devices 102-106 to the first monitoring circuit 120a. Further, the interrupt handling circuit 118 may provide one or more second interrupts (e.g., one or more second interrupt identifiers) associated with any of the one or more peripheral devices 102-106 to the second monitoring circuit 120b. The operations of the interrupt handling circuit 118 have been explained in further detail at least in FIG. 2.

The first monitoring circuit 120a and the second monitoring circuit 120b may be structurally and functionally similar. Each of the first monitoring circuit 120a and the second monitoring circuit 120b may include suitable code, logic, circuitry, and/or interfaces to execute one or more operations. In one example, each of the first monitoring circuit 120a and the second monitoring circuit 120b may be configured to receive the one or more first interrupts and the one or more second interrupts, from the interrupt handling circuit 118 and monitor the one or more first interrupts and the one or more second interrupts, respectively. For the sake of simplicity of explaining the ongoing description, the operations of the first monitoring circuit 120a has been explained in detail. Similar operations may be performed by the second monitoring circuit 120b as will be understood by a person skilled in the art. Further, the one or more first interrupts have hereinafter alternatively been referred to as “one or more interrupts”.

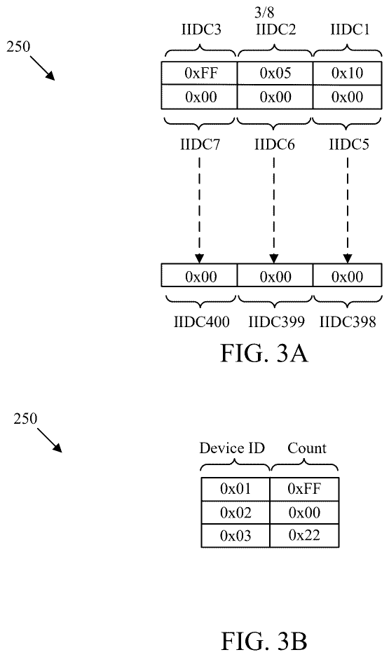

To monitor each interrupt, the first monitoring circuit 120a may further be configured to track, a frequency of occurrence of the one or more interrupts in a monitoring interval. Further stated, the first monitoring circuit 120a may track in the monitoring interval, a number of times an interrupt has occurred or a number of instances of the one or more interrupts. Each of the one or more interrupts may be associated with an identifier. The identifier may include numbers, alphabets, or alphanumeric characters. In one aspect, each of the one or more interrupts may have a same (e.g., an identical) identifier. In further aspects, each of the one or more interrupts may have a different identifier. The first monitoring circuit 120a may be further configured to generate an error signal based on the frequency of occurrence of the one or more interrupts exceeding a threshold value. The frequency of occurrence of the one or more interrupts exceeding the threshold value may indicate to the first monitoring circuit 120a that the peripheral device associated with the one or more interrupts may be malicious or faulty. For the sake of simplicity of explaining the ongoing disclosure and without deviating from the scope of the disclosure, it is assumed that the one or more interrupts received by the first monitoring circuit 120a are associated with the first peripheral device 102. However, in various aspects, the one or more interrupts may be associated with any of the peripheral devices 102-106. The operations of the first monitoring circuit 120a have been explained in further detail at least in FIGS. 2 and 3.

In one aspect, the error signal may be provided to a host processor of the SoC 108. In one example, the first peripheral device 102 may be faulty due to structural faults associated with aging or functional faults in the first peripheral device 102. Thus, based on the reception of the error signal, the host processor may diagnose the faults in the first peripheral device 102 and disable at least one of the one or more interrupts or the first peripheral device 102 for a time period. At least one of the one or more interrupts or the first peripheral device 102 may be re-enabled upon the handling of the faults in the first peripheral device 102. In further aspects, the host processor may identify that the first peripheral device 102 may be malicious and disable the first peripheral device 102 from further generating any interrupts. It will be understood by a person skilled in the art that various other corrective actions may be performed upon the reception of the error signal that may be based on the requirements of the system 100.

In further aspects, the first monitoring circuit 120a may further be configured to provide the one or more interrupts to the first processor 114 based on the frequency of occurrence of the one or more interrupts being lower than or equal to the threshold value. Further stated, the first monitoring circuit 120a may provide the first LPIs to the first processor 114 based on a priority level of each of the first LPIs. Thus, an interrupt (e.g., an LPI) having a highest priority may be provided to the first processor 114 prior to an interrupt (e.g. a different LPI) having a lower priority.

In one aspect, the monitoring interval may be triggered periodically upon a bootup of the system 100. In further aspects, the monitoring interval may be triggered based on an occurrence of one of the one or more interrupts upon the bootup of the system 100. In such an aspect, after the expiry of the monitoring interval, the monitoring interval may be retriggered based on an occurrence of one of the one or more interrupts.

The one or more memories 112 may be configured to store at least interrupt identifiers and an identifier of each of the monitoring circuits 120a and 120b. The one or more memories 112 may be controlled by the host processor and the interrupt controller 110. The one or more memories 112 may be further configured to store a plurality of tables (as described in FIGS. 2 and 3) that may be associated with the management of the one or more interrupts. Examples of the one or more memories 112 may include a random-access memory (RAM), a read only memory (ROM), a programmable ROM (PROM), an erasable PROM (EPROM), an electrically erasable PROM (EEPROM), and any other suitable medium for storing commands, software, and/or instructions that may be accessed and read by the host processor, the first processor 114, the second processor 116, and/or the interrupt controller 110. In further aspects, the one or more memories 112 may be a non-transitory computer-readable medium.

Each of the first processor 114 and the second processor 116 may be configured to perform one or more operations associated with the one or more first interrupts and the one or more second interrupts, respectively. In one aspect, the first processor 114 and the second processor 116 may correspond to processing cores of the host processor, e.g., a host central processing unit (CPU). In further aspects, the first processor 114 and the second processor 116 may correspond to various processors such as a secure processor, an audio processor, or the like, of the SoC 108. In further aspects, the first processor 114 and the second processor 116 may correspond to a CPU and a general processing unit. Examples of the first processor 114 and the second processor 116 may include, but may not be limited to, an application-specific integrated circuit (ASIC) processor, a reduced instruction set computer (RISC) processor, a complex instruction set computer (CISC) processor, a field programmable gate array (FPGA), or the like.

Though the interrupt controller 110, the one or more memories 112, the first processor 114, and the second processor 116 are shown to be included in the SoC 108, in various aspects, any of the interrupt controller 110, the one or more memories 112, the first processor 114, and the second processor 116 may be external to the SoC 108.

Though it is mentioned that the error signal may be generated based on the frequency of occurrence of the one or more interrupts exceeding the threshold value, in various aspects, the error signal may be generated based on the frequency of occurrence of the one or more interrupts matching the threshold value.

Though FIG. 1 shows the peripheral devices 102-106, in various aspects, the system 100 may include at least two hundred and fifty-five peripheral devices.

Though FIG. 1 shows the first processor 114 and the second processor 116, it will be understood by a person skilled in the art that, the system 100 may include more than two processors.

Though FIG. 1 shows the first monitoring circuit 120a and the second monitoring circuit 120b, it will be understood by a person skilled in the art that, the system 100 may include more than two monitoring circuits that may be associated with a number of the processors.

In various aspects, any of the peripheral devices 102-106 may be integrated within a device that includes the SoC 108.

In various aspects, any of the peripheral devices 102-106 may be external to a device that includes the SoC 108.

FIG. 2 is a diagram that illustrates the SoC 108, in accordance with certain aspects of the present disclosure. FIG. 2 has been explained in conjunction with FIG. 1. The SoC 108 may include the interrupt controller 110, the one or more memories 112, and the first processor 114. The interrupt controller 110 may include the interrupt handling circuit 118 and the first monitoring circuit 120a. The first monitoring circuit 120a may include a monitoring logic 212. In one aspect, the interrupt controller 110 may include a register bank 214. In one example, the first monitoring circuit 120a may include the register bank 214. The register bank 214 may include a configuration register 216, a pending register 220, a monitoring register 224, an interval register 228, and a threshold register 232. The one or more memories 112 may be configured to store a device table 236, a translation table 238, a collection table 240, a configuration table 242, a pending table 246, and a monitoring table 250. The one or more memories 112 may be further configured to store multiple translation tables that may be associated with a number of the peripheral devices 102-106. However, for the sake of simplicity of explaining FIG. 2, a single translation table, e.g., the translation table 238, associated with the first peripheral device 102 is shown.

The interval register 228 may be configured to store a timer value indicative of the monitoring interval. Examples of the timer value may include 3 seconds, 200 milliseconds, 10 minutes, or the like. In one aspect, the timer value may be configurable. In further aspects, the timer value may be predefined. The timer value being configurable may refer to adjusting the timer value dynamically based on one or more parameters. The one or more parameters may include a current load of the system 100, historical data, or the like. The first monitoring circuit 120a may dynamically adjust the timer value during each boot up of the system 100. In one aspect, the first peripheral device 102 may be a critical peripheral device. Further, the historical data may indicate the timer value of 3 seconds. Thus, the timer value associated with the one or more interrupts generated by the first peripheral device 102 may be configured with a lower value (e.g., 3 seconds or lower than 3 seconds, e.g., 200 milliseconds) as compared to timer values associated with the second peripheral device 104 and the third peripheral device 106 that may have low criticality as compared to the first peripheral device 102. In further aspects, the timer value may be a lower value during a high processing load (e.g., a number of multiple operations being executed simultaneously) on the system 100, as compared to the timer value during a low processing load on the system 100 (e.g. in an idle mode of the system 100). In one example, to manage the load on the system 100, the timer value may be 100 milliseconds during a high processing load and 200 milliseconds during a low processing load on the system 100.

The first monitoring circuit 120a may further include a timer that may be loaded with the timer value. The first monitoring circuit 120a may trigger the timer to increment until an end of the monitoring interval. Further, the timer may generate a timeout signal at an end of the monitoring interval. Based on the generation of the timeout signal, the first monitoring circuit 120a may reset the timer. In one aspect, the timer may be triggered by the first monitoring circuit 120a upon the boot up of the system 100. The timer may reset at an end of the monitoring interval and may be retriggered by the first monitoring circuit 120a at the end of the monitoring interval. Examples of the timer may include a hardware timer, a software timer, an up counter, a down counter, or the like. The first monitoring circuit 120a may refer to the interval register 228 to access the timer value for a current monitor interval.

The threshold register 232 may be configured to store the threshold value. In one aspect, the threshold value may be configurable. In further aspects, the threshold value may be predefined. In one aspect, the first monitoring circuit 120a may configure the threshold value in the threshold register 232 prior to the generation of the one or more interrupts (e.g., the first interrupt information) by the first peripheral device 102 based on the historical data and the current load of the system 100.

In one aspect, based on the historical data, the threshold value may be configured with a historical threshold value of 15 interrupts. In further aspects, the threshold value associated with the interrupts from each of the peripheral devices 102-106 may be configured with a different threshold value, e.g., 255. In further aspects, the first peripheral device 102 may be a critical peripheral device. Further, in an idle mode or a low power mode of the system 100 indicating a low processing load on the system 100, the threshold value may be configured with a higher value as compared to the threshold value during a high processing load on the system 100. In one example, the threshold value may be ‘500’ during a low processing load and ‘250’ during a high processing load on the system 100. The first monitoring circuit 120a may refer to the threshold register 232 to access the threshold value for a current monitoring interval.

The configuration register 216 may point to a first memory region of the one or more memories 112. Further stated, the configuration register 216 may be configured to store a base address (denoted as “ADC” in FIG. 2) of the configuration table 242. The first monitoring circuit 120a may be further configured to access the configuration table 242 via the configuration register 216.

The pending register 220 may point to a second memory region of the one or more memories 112 that may track a pending state of each interrupt identifier. Further stated, the pending register 220 may be configured to store a base address (denoted as “ADP” in FIG. 2) of the pending table 246. The first monitoring circuit 120a may be further configured to access the pending table 246 via the pending register 220.

The monitoring register 224 may point to a third memory region of the one or more memories 112. Further stated, the monitoring register 224 may be configured to store a base address (denoted as “ADM” in FIG. 2) of the monitoring table 250. The first monitoring circuit 120a may be further configured to access the monitoring table 250 via the monitoring register 224.

The device table 236 may be configured to store a list of device identifiers of each of the peripheral devices 102-106. Further stated, the device table 236 may be configured to store a mapping between each device identifier associated with a peripheral device and a translation identifier associated with each translation table. Further stated, based on a reception of an interrupt (e.g., an event identifier and a device identifier) from the first peripheral device 102, the interrupt handling circuit 118 may look up a translation identifier (denoted as “translation ID” in FIG. 2) associated with the device identifier of the first peripheral device 102 in the device table 236, to identify the translation table 238. In one aspect, the device table 236 may be updated with the device identifiers of the peripheral devices 102-106 by the host processor of the SoC 108.

The translation table 238 may be configured to store interrupt identifiers associated with the event identifiers. Further stated, the translation table 238 may store a list of the interrupt identifiers (e.g., LPI identifiers) associated with each event identifier (e.g., a message signal identifier (MSI)) of the first peripheral device 102. The interrupt handling circuit 118 may thus be configured to translate the event identifier (e.g., a message-based interrupt) to a corresponding interrupt identifier (e.g., an LPI) via the translation table 238. In one aspect, the event identifier and the interrupt identifiers (denoted as “interrupt IDs” in FIG. 2) may have a same identifier. In further aspects, the event identifier and the interrupt identifier may have a different identifier. In one example, the event identifiers may range from 0 to 2000. In further examples, a collection of event identifiers may have a single interrupt identifier. In one aspect, the host processor of the SoC 108 may determine the interrupt identifiers for each event identifier and store the interrupt identifiers in the translation table 238.

The collection table 240 may be configured to store a mapping between a set of LPIs and a corresponding processor (e.g. a monitoring circuit associated with the processor). The mapping may indicate a processor to handle the LPIs. Further stated, the interrupt handling circuit 118 may be configured to determine a monitoring circuit (e.g., retrieve an identifier of a monitoring circuit, denoted as “MC ID” in FIG. 2). The monitoring circuit may be determined to manage the LPI (e.g., the interrupt identifier) and route the interrupt identifier to the associated processor based on the mapping indicated in the collection table 240. In one aspect, the collection table 240 may be updated with the identifiers of the monitoring circuits 120a and 120b by the host processor of the SoC 108.

The one or more memories 112 may include a single configuration table 242 that may be shared by each of the monitoring circuits 120a and 120b. The configuration table 242 may be configured to store a priority level of each interrupt identifier associated with the peripheral devices 102-106. Further stated, the configuration table 242 may include the priority level and the configuration of each interrupt identifier (denoted as “interrupt IDs” in FIG. 2). In one example, the one or more interrupts may include first through third interrupts that may have first through third interrupt identifiers, respectively, associated with the first peripheral device 102. Further, the first interrupt identifier may be indicative of the highest priority, the second interrupt identifier may be indicative of an intermediate priority, and the third interrupt identifier may be indicative of a lowest priority. The first monitoring circuit 120a may thus provide the first interrupt to the first processor 114, followed by the second interrupt, and the third interrupt, respectively.

The first monitoring circuit 120a may be further configured to access the configuration table 242 via the configuration register 216. When the first monitoring circuit 120a may receive the interrupt (e.g., the interrupt identifier), the first monitoring circuit 120a may refer to the configuration table 242 via the base address stored in the configuration register 216. The first monitoring circuit 120a may be further configured to retrieve a priority level of at least one of the one or more interrupts from the accessed configuration table 242, based on each occurrence of an interrupt in the monitoring interval. The first monitoring circuit 120a may be further configured to disable the one or more interrupts in the accessed configuration table 242 based on the generation of the error signal. In one aspect, the priority level may be updated in the configuration table 242 by the host processor of the SoC 108. In further aspects, the priority level may be updated in the configuration table 242 by the interrupt controller 110.

Each of the monitoring circuits 120a and 120b may have a corresponding pending table which may not be shared with different monitoring circuits. Thus, the pending table 246 may be associated with the first monitoring circuit 120a. The pending table 246 may include one or more bits associated with the one or more interrupts. In one example, the pending table 246 may include one bit for each interrupt. The one or more bits may indicate a status of the one or more interrupts. In one example, the pending table 246 may include 8 bits associated with 8 interrupts. In further examples, for 400 interrupt identifiers, the pending table 246 may include 400 bits. The one or more bits in the pending table 246 may either be enabled to indicate a pending status or disabled based on one of the generation of the error signal or servicing of the one or more interrupts by the first processor 114. In one example, a first bit of the pending table 246 may be set to “1” to indicate a pending state of the first interrupt or “0” to indicate an inactive state of the first interrupt.

The first monitoring circuit 120a may update a status of the corresponding interrupt (e.g., the interrupt identifier) as pending in the pending table 246 based on the retrieval of the priority level of the interrupt from the configuration table 242. Further stated, the first monitoring circuit 120a may be further configured to enable the one or more bits, associated with the one or more interrupts, in the pending table 246 based on the retrieval of the priority level of each interrupt, respectively. The first monitoring circuit 120a may be further configured to disable, based on the generation of the error signal, the one or more bits associated with the one or more interrupts, respectively, in the accessed pending table 246. The first monitoring circuit 120a may be further configured to retain the pending status of an interrupt in the pending table 246 until an end of the monitoring interval. The first monitoring circuit 120a may be further configured to clear the pending status of the interrupt in the pending table 246 based on the generation of the error signal.

In one aspect, the first monitoring circuit 120a may be configured to set the bit in the pending table 246 based on the reception of an interrupt of the one or more interrupts. In further aspects, the interrupt handling circuit 118 may be configured to set the bit in the pending table 246 based on the provision of the interrupt to the first monitoring circuit 120a. The first monitoring circuit 120a may be further configured to clear the pending bits when the one or more interrupts may be handled. In one example, the first monitoring circuit 120a may provide the interrupt to the first processor 114 based on the corresponding bit associated with the interrupt being enabled in the pending table 246.

The monitoring table 250 may be configured to track a total frequency of occurrence of the one or more interrupts (e.g., the LPIs) generated by the first peripheral device 102. Further stated, the monitoring table 250 may be indicative of a number of times an interrupt has occurred in the monitoring interval. The monitoring register 224 may point to a memory region of the one or more memories 112 that may log the frequency of occurrence of the one or more interrupts (e.g., maintain a count indicative of the frequency of occurrence of the one or more interrupts). Further, the count may be incremented with each occurrence of an interrupt in the monitoring interval. The count in the monitoring table 250 may be cleared at the end of each monitoring interval.

The first monitoring circuit 120a may be further configured to access the monitoring table 250 via the monitoring register 224 to track the frequency of occurrence of the one or more interrupts. The first monitoring circuit 120a may be further configured to increment the count in the monitoring table 250 based on an occurrence of an interrupt of the one or more interrupts in the monitoring interval. The first monitoring circuit 120a may be further configured to determine, in the monitoring interval, based on the count in the monitoring table 250, whether the frequency of the occurrence of the one or more interrupts has exceeded the threshold value. The first monitoring circuit 120a may be further configured to generate the error signal based on the determination that the frequency of occurrence of the one or more interrupts has exceeded the threshold value.

In one aspect, the monitoring table 250 may include a count for each interrupt identifier. Each of the one or more interrupts may have a same identifier. Further stated, the identifier associated with the interrupt may be an interrupt identifier that uniquely identifies an interrupt. Thus, the first monitoring circuit 120a may be further configured to increment the count of the monitoring table 250 based on each occurrence of an interrupt having the same identifier, in the monitoring interval. A size of the monitoring table 250 may be based on at least one of a total number of interrupts associated with the first peripheral device 102 or the threshold value. In one example, the size of the monitoring table 250 may be ‘N’ bytes where ‘N’ may be a number of interrupts that may be supported by the peripheral devices 102-106. Further stated, the size of the monitoring table 250 may be based on a total number of identifiers of the one or more interrupts. In further examples, the threshold value may be 15 for each interrupt. In additional examples, the size of the monitoring table 250 may be one byte or 8 bits for each interrupt.

In one scenario, the first monitoring circuit 120a may be configured to manage 400 interrupts. Thus, the monitoring table 250 may be divided into 400 blocks to count each of the 400 interrupts. Further, for each interrupt having a specific identifier, the count in the corresponding block in the monitoring table 250 may be incremented until the threshold value may be reached. In one example, the first interrupt having the first identifier may be triggered 16 times which may be the threshold value whereas the second interrupt having the second identifier may be triggered 3 times which is lower than the threshold value. Thus, the count for the first interrupt identifier may be 16 whereas the count for the second interrupt identifier may be 3. Thus, in one aspect, the first peripheral device 102 associated with the first interrupt may be identified to be malicious or faulty based on the count of the first interrupt identifier exceeding the threshold value. In such an aspect, the first peripheral device 102 may be disabled for a time period to disable generation of further interrupts in the time period. In further aspects, the first interrupt may be identified to be erroneously generated based on the count of the first interrupt identifier exceeding the threshold value. In such an aspect, the generation of the first interrupt may be disabled without disabling the first peripheral device 102.

In further aspects, the monitoring table 250 may include a mapping between a device identifier and the number of interrupts associated with the device identifier in the monitoring table 250. The one or more interrupts may be associated with a device identifier that uniquely identifies a peripheral device coupled to the interrupt controller 110. In one example, the one or more interrupts may be associated with the first device identifier of the first peripheral device 102. Further, the one or more interrupts may have at least one of a same interrupt identifier or a different interrupt identifier. Thus, the first monitoring circuit 120a may be further configured to increment the count of the monitoring table 250 based on the device identifier. Further stated, based on each occurrence of an interrupt having at least one of the same interrupt identifier or the different interrupt identifier, in the monitoring interval, the count associated with the device identifier may be incremented.

A size of the monitoring table 250 may be ‘2N’ bytes where ‘N’ may be a number of device identifiers mapped with each of the peripheral devices 102-106. In one example, each peripheral device may support 200 interrupts. Further, a number of the peripheral devices 102-106 may be 10. Thus, the total size of the monitoring table 250 may be 200*10, that may be 2000 bytes.

The first monitoring circuit 120a may be configured to control each register of the register bank 214 via a monitoring logic 212. The monitoring logic 212 may include suitable circuitry, code, logic, interfaces that enable the first monitoring circuit 120a to execute one or more operations as discussed in the disclosure. Further stated, the first monitoring circuit 120a may be configured to execute one or more operations of the first monitoring circuit 120a via the monitoring logic 212. The first monitoring circuit 120a upon receiving the one or more interrupts, may increment the count associated with the corresponding device identifier in the monitoring table 250. If the monitoring logic 212 may determine that the count for the device identifier may exceed the threshold value within the current monitoring interval, the monitoring logic 212 may further determine that the first peripheral device 102 may be defective and generate the error signal. Based on the generation of the error signal, the monitoring logic 212 may further disable all the interrupts associated with the first peripheral device 102 in the pending table 246 and the configuration table 242 to prevent the interrupts from being scheduled to the first processor 114. The error signal may further be provided to the host processor or circuitry of the interrupt controller 110 to further handle the corrective actions. The operations executed by the monitoring logic 212 are explained via the first monitoring circuit 120a in the ongoing disclosure.

In operation, the first peripheral device 102 may generate one or more interrupts (e.g., an MSI) via one or more event identifiers and the device identifier. The interrupt handling circuit 118 may thus receive the device identifier and the one or more event identifiers indicative of one or more interrupts, from the first peripheral device 102. The interrupt handling circuit 118 may further translate, based on the device table 236 and the translation table 238, the device identifier and the one or more event identifiers to generate the one or more interrupts having an identifier. The interrupt handling circuit 118 may further map the one or more interrupts to the first monitoring circuit 120a based on the collection table 240. The priority level of the one or more interrupts may be indicated in the configuration table 242, and the pending table 246 may be updated to indicate the one or more interrupts to be pending by way of one or more corresponding enabled bits in the pending table 246. The one or more bits may remain pending until an end of the monitoring interval. Further, the count of a corresponding register in the monitoring table 250 may be incremented by one, based on each reception of an interrupt in the monitoring interval. In one aspect, the one or more interrupts may include a first interrupt that may have an interrupt identifier (e.g., a first interrupt identifier) to uniquely identify the first interrupt. In further aspects, the one or more interrupts may include the first interrupt and the second interrupt that may have the first interrupt identifier and the second interrupt identifier, respectively, that may be further associated with the first device identifier of the first peripheral device 102. Thus, the first monitoring circuit 120a may increment the count in the monitoring table 250 until the count may exceed the threshold value, to track the frequency of occurrence of the one or more interrupts. In one example, the count associated with the first interrupt identifier may be incremented in the monitoring table 250. In further examples, the count associated with the first device identifier may be incremented in the monitoring table 250. When the count may exceed the threshold value, the first monitoring circuit 120a may determine that the one or more interrupts may be triggered by a defective or malicious peripheral device and generate the error signal. Based on the generation of the error signal, the first monitoring circuit 120a may disable the one or more interrupts in the configuration table 242 and the corresponding one or more enabled bits in the pending table 246 thereby preventing the one or more interrupts from being scheduled to the first processor 114.

It will be understood by a person skilled in the art that if the frequency of occurrence of the one or more interrupts may be lower than the threshold value, the first monitoring circuit 120a may provide the one or more interrupts to the first processor 114. Further, the one or more bits in the pending table 246 may be cleared based on the provision of the interrupt. Further, the configuration table 242 may be updated to reflect the provision of the one or more interrupts. In addition, the corresponding count in the monitoring table 250 may be cleared.

Though the one or more interrupts are shown to be associated with the first peripheral device 102, in various aspects, the one or more interrupts may be associated with multiple peripheral devices. Further, the second peripheral device 104 and the third peripheral device 106 may generate the one or more interrupts having the same identifier along with the first peripheral device 102. The interrupt controller 110 may thus manage the one or more interrupts associated with the interrupt identifier from any of the peripheral devices 102-106.

It will be understood by a person skilled in the art that the second monitoring circuit 120b may manage the one or more second interrupts in a manner similar to the management of the one or more first interrupts by the first monitoring circuit 120a.

FIGS. 3A and 3B are diagrams that illustrate the monitoring table 250, in accordance with certain aspects of the present disclosure. FIGS. 3A and 3B are explained in conjunction with FIG. 1 and FIG. 2. Referring to FIG. 3A, in one aspect, the monitoring table 250 may include a mapping between a count associated with each interrupt. In one example, each of the peripheral devices 102-106 may be configured to support 400 interrupts. Further stated, the monitoring table 250 may include a register space for the count associated with each of the 400 interrupts. Each interrupt may be associated with an interrupt identifier (ID). In one aspect, each interrupt ID may be associated with one of the peripheral devices 102-106. In further aspects, each interrupt ID may be associated with more than one of the peripheral devices 102-106.

The first monitoring circuit 120a may access the monitoring table 250 via the monitoring register 224. A size of the monitoring table 250 may be based on the total number of interrupts and the threshold value. In one example, a size of each interrupt may be one byte. Thus, the size of the monitoring table 250 may be 400 bytes. In one example, the threshold value may be 255 or 0xFF. Thus, the count for each interrupt ID may be incremented up to 255 times in the monitoring interval. Further, the first monitoring circuit 120a may be unable to increment the count beyond 255 thereby indicating that the count has exceeded the threshold value. In further examples, the threshold value may be 254 or 0xFE. Thus, the count for each interrupt ID may be incremented one more than the threshold value e.g., up to 255 times in the monitoring interval. The first monitoring circuit 120a may thus determine that the count has exceeded the threshold value of 254 and generate the error signal.

In one scenario, a fifth interrupt, a sixth interrupt, a seventh interrupt, a three hundred and ninety eighth interrupt, a three hundred and ninety ninth interrupt, and a four hundredth interrupt have not been triggered in the corresponding monitoring interval. Thus, the count associated with each of the fifth interrupt identifier IIDC5, the sixth interrupt identifier IIDC6, the seventh interrupt identifier IIDC7, the three hundred and ninety eighth interrupt identifier IIDC398, the three hundred and ninety ninth interrupt identifier IIDC399, and the four hundredth interrupt identifier IIDC400 may be 0x00.

In further scenarios, in the current monitoring interval, the first peripheral device 102 may trigger a first interrupt IID1, the second peripheral device 104 may trigger a second interrupt IID2, and the third peripheral device 106 may trigger a third interrupt IID3 0x10, 0x05, 0xFF times, respectively. In yet further scenarios, the first peripheral device 102 may trigger the first interrupt IID1, the second interrupt IID2, and the third interrupt IID3 0x10, 0x05, 0xFF times in the current monitoring interval. Thus, the count corresponding to each of the first interrupt identifier IIDC1, a second interrupt identifier IIDC2, and a third interrupt identifier IIDC3 may be 0x10, 0x05, 0xFF, respectively. Since the count corresponding to the third interrupt identifier IIDC3 has exceeded the threshold value (e.g., 0xFE), the first monitoring circuit 120 a may disable the third interrupt identifier IID3 in the configuration table 242, disable the bit associated with the third interrupt identifier in the pending table 246, and raise the error signal.

Referring to FIG. 3B, in one aspect, the monitoring table 250 may include a mapping between a count associated with each device identifier. The size of the monitoring table 250 may be 2N Bytes where ‘N’ may be the number of device identifiers. The first peripheral device 102 may generate the one or more interrupts in the monitoring interval. Each time an interrupt may be received by the first monitoring circuit 120a, the count associated with the corresponding device identifier in the monitoring table 250 may be incremented by one. If the count for any device identifier may exceed the threshold value, the first monitoring circuit 120a may determine that the corresponding peripheral device may be a defective peripheral device and generate the error signal. Thus, the first peripheral device 102 may be identified with the first device identifier ID1, the second peripheral device 104 may be identified with the second device identifier ID2, and the third peripheral device 106 may be identified with the third device identifier ID3.

In the current monitoring interval, the one or more interrupts (e.g., the one or more first interrupts) associated with the first device identifier ID1 (e.g., 0x01) may be triggered 255 times (e.g., 0xFF), the one or more second interrupts associated with the second device identifier ID2 (e.g., 0x02) may not be triggered (e.g., 0x00), and the one or more third interrupts associated with the third device identifier ID3 (e.g., 0x03) may be triggered 0x22 (e.g., 34 times). Since the count corresponding to 0x01 may be 0xFF indicating that the count associated with the first device identifier may have exceeded the threshold value, the first monitoring circuit 120a may disable the one or more first interrupts associated with the first peripheral device 102 in the configuration table 242 and generate the error signal. Based on the generation of the error signal, the first monitoring circuit 120a may prevent the one or more first interrupts associated with the first peripheral device 102 from being scheduled to the first processor 114.

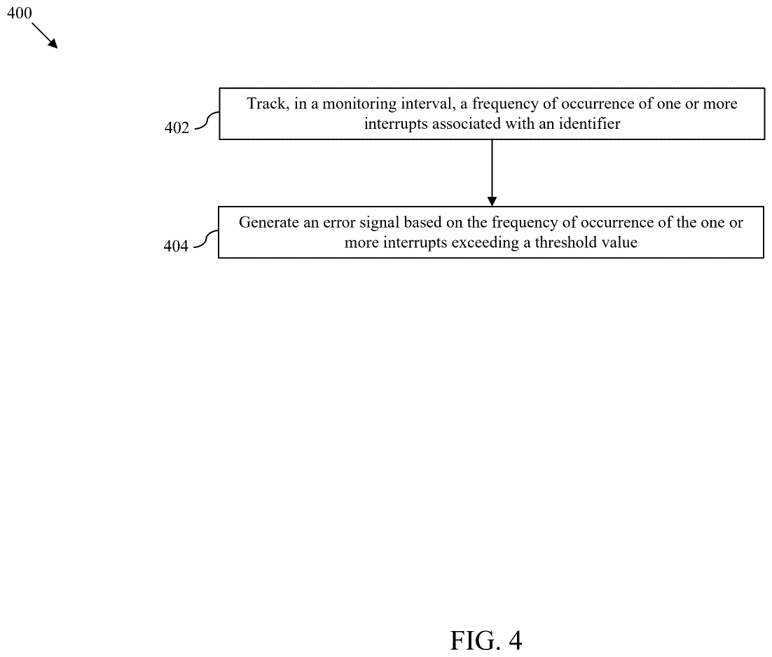

FIG. 4 is a diagram that illustrates a high-level flowchart 400 of a method (e.g., a process) executed by a monitoring circuit of the interrupt controller 110, in accordance with an exemplary aspect of the present disclosure. The high-level flowchart 400 has been explained in reference to the first monitoring circuit 120a. FIG. 4 has been explained in conjunction with FIG. 1-3B.

At 402, a frequency of occurrence of one or more interrupts associated with an identifier may be tracked in a monitoring interval. The first monitoring circuit 120a may access the monitoring table 250 via the monitoring register 224 to track the frequency of occurrence of the one or more interrupts. The one or more interrupts may be associated with at least one of the peripheral devices 102-106. Further, the one or more interrupts may have a same identifier or different identifiers. The monitoring table 250 may maintain a count of each interrupt to indicate the frequency of occurrence of the one or more interrupts. Further, the frequency of occurrence of the one or more interrupts may be tracked in the monitoring interval.

At 404, an error signal may be generated, based on the frequency of occurrence of the one or more interrupts exceeding a threshold value. If the count in the monitoring table 250 may indicate that the frequency of occurrence of the one or more interrupts may have exceeded the threshold value, the first monitoring circuit 120a may generate the error signal. The generation of the error signal may indicate that the first peripheral device 102 may be malicious or faulty.

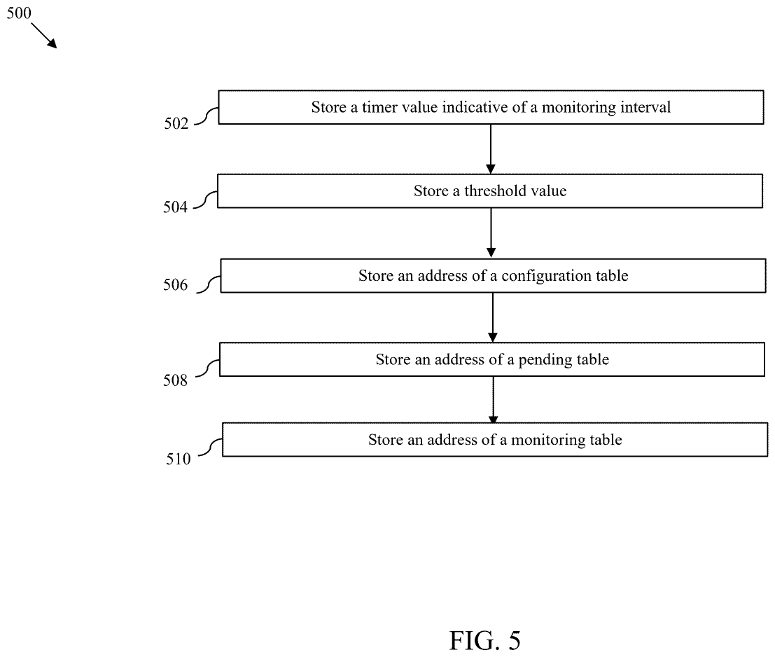

FIG. 5 is a diagram that illustrates a flowchart 500 of a method (e.g., a process) executed at the register bank 214, in accordance with an exemplary aspect of the present disclosure. 502, 504, 506, 508, and 510 may be executed parallelly. FIG. 5 has been explained in conjunction with FIG. 1-4.

At 502, a timer value indicative of a monitoring interval may be stored. The interval register 228 may store the timer value indicative of the monitoring interval. In one aspect, the first monitoring circuit 120a may configure the timer value in the interval register 228. In one example, the timer value may be configured based on historical data and current load of the system 100. In further examples, the timer value may be predefined. Further, the timer value may be configured prior to the generation of the interrupts by any of the peripheral devices 102-106 based on a boot up of the system 100.

At 504, a threshold value may be stored. The threshold register 232 may store the threshold value. In one aspect, the threshold value may be configurable and be based on the historical data and the current load of the system 100. In further aspects, the threshold value may be predefined. In one scenario, the first monitoring circuit 120a may configure the threshold value in the threshold register 232 prior to the generation of the one or more interrupts by the peripheral devices 102-106.

At 506, an address of a configuration table 242 may be stored. The configuration register 216 may store the base address of the configuration table 242. The first monitoring circuit 120a may access the configuration table 242 via the base address stored in the configuration register 216. In one aspect, the host processor of the SoC 108 may store the base address of the configuration table 242 in the configuration register 216.

At 508, an address of a pending table 246 may be stored. The pending register 220 may store the base address of the pending table 246. The first monitoring circuit 120a may access the pending table 246 via the base address stored in the pending register 220. In one aspect, the host processor of the SoC 108 may store the base address of the pending table 246 in the pending register 220.

At 510, an address of a monitoring table 250 may be stored. The monitoring register 224 may store the base address of the monitoring table 250. The first monitoring circuit 120a may access the monitoring table 250 via the base address stored in the monitoring register 224. In one aspect, the host processor of the SoC 108 may store the base address of the monitoring table 250 in the monitoring register 224.

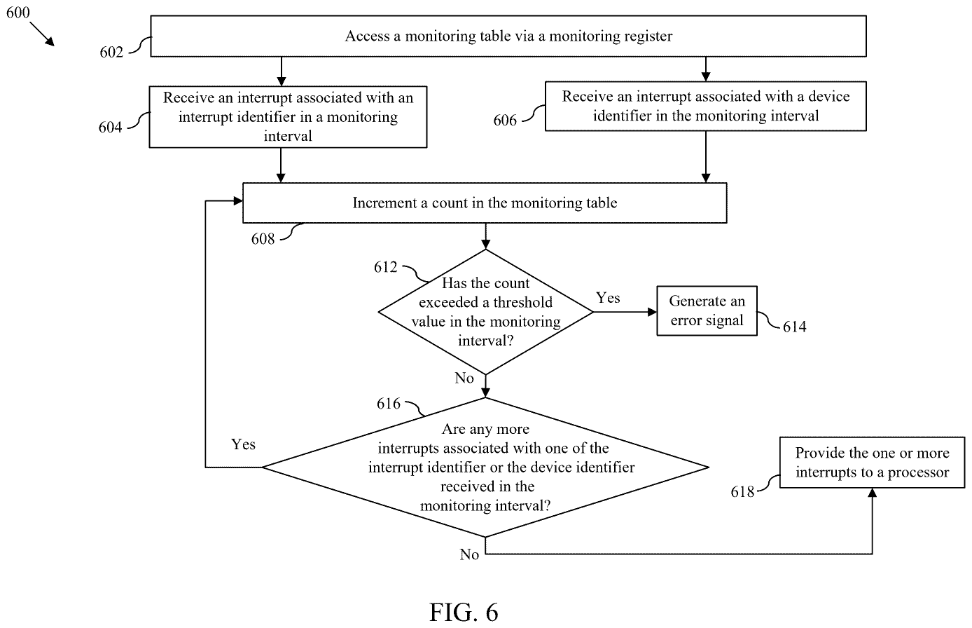

FIG. 6 is a diagram that illustrates a flowchart 600 of a method (e.g., a process) executed by the monitoring circuit of the interrupt controller 110, in accordance with an exemplary aspect of the present disclosure. FIG. 6 has been explained in reference to the first monitoring circuit 120a. Further, FIG. 6 has been explained in conjunction with FIG. 1-5.

At 602, a monitoring table 250 via a monitoring register 224 may be accessed. The first monitoring circuit 120a may access the monitoring table 250 via the monitoring register 224. After 602, 604 and 606 may be executed parallelly. In further aspects, 602 may occur based on either of 604 or 606.

At 604, an interrupt associated with an interrupt identifier, in a monitoring interval may be received. The first monitoring circuit 120a may receive the one or more interrupts associated with the first peripheral device 102. The first monitoring circuit 120a may further track the frequency of occurrence of the one or more interrupts via the monitoring table 250 based on the reception of the one or more interrupts. Each interrupt may be associated with a single interrupt identifier.

At 606, an interrupt associated with a device identifier of the peripheral device may be received in the monitoring interval. The first monitoring circuit 120a may receive the one or more interrupts that may be associated with one or more interrupt identifiers. Further, the one or more interrupt identifiers may be associated with the first device identifier of the first peripheral device 102.

At 608, a count of the monitoring table 250 may be incremented. The first monitoring circuit 120a may increment the count of the monitoring table 250 based on each reception of the one or more interrupts in the monitoring interval. In one aspect, when each of the one or more interrupts may be associated with an interrupt identifier (e.g., each interrupt may have a same identifier), the count of the monitoring table 250 may be incremented based on each occurrence of an interrupt, in the monitoring interval, having the same identifier. In further aspects, when the one or more interrupts may be associated with a device identifier (e.g., have at least one of a same identifier or a different identifier), the count of the monitoring table 250 may be incremented based on each occurrence of the one or more interrupts associated with the device identifier, in the monitoring interval. Further stated, the count for the one or more interrupts associated with each device identifier (e.g., the first device identifier) may be incremented.

At 612, it is determined whether the count has exceeded a threshold value in the monitoring interval. The first monitoring circuit 120a may determine, in the monitoring interval, based on the count in the monitoring table 250, whether the frequency of occurrence of the one or more interrupts has exceeded the threshold value. In one aspect, the count associated with the one or more interrupts having the same identifier may be compared with the threshold value to determine whether the frequency of occurrence of the one or more interrupts has exceeded the threshold value. In further aspects, the count associated with the one or more interrupts having at least one of a same identifier or a different identifier may be compared with the threshold value to determine whether the frequency of occurrence of the one or more interrupts has exceeded the threshold value. If at 612, it is determined that the frequency of occurrence of the one or more interrupts has exceeded the threshold value, 614 may be executed. If at 612, it is determined that the frequency of occurrence of the one or more interrupts is lower than the threshold value, 616 may be executed.

At 614, an error signal may be generated. The first monitoring circuit 120a may generate the error signal, based on the determination that the frequency of occurrence of the one or more interrupts has exceeded the threshold value. The generation of the error signal may be indicative of disablement of the one or more interrupts.

At 616, it is determined whether any more interrupts associated with one of the interrupt identifier or the device identifier may be received in the monitoring interval. The first monitoring circuit 120a may determine whether further interrupts associated with the first peripheral device 102 are received in the monitoring interval. If at 616, it is determined that further interrupts associated with one of the interrupt identifier or the device identifier may be received in the monitoring interval, 608 may be executed. If at 616, it is determined that further interrupts associated with one of the interrupt identifier or the device identifier may not be received in the monitoring interval, 618 may be executed.

At 618, the one or more interrupts may be provided to a processor. The first monitoring circuit 120a may provide the one or more interrupts to the first processor 114 based on the frequency of the occurrence of the one or more interrupts being lower than the threshold value.

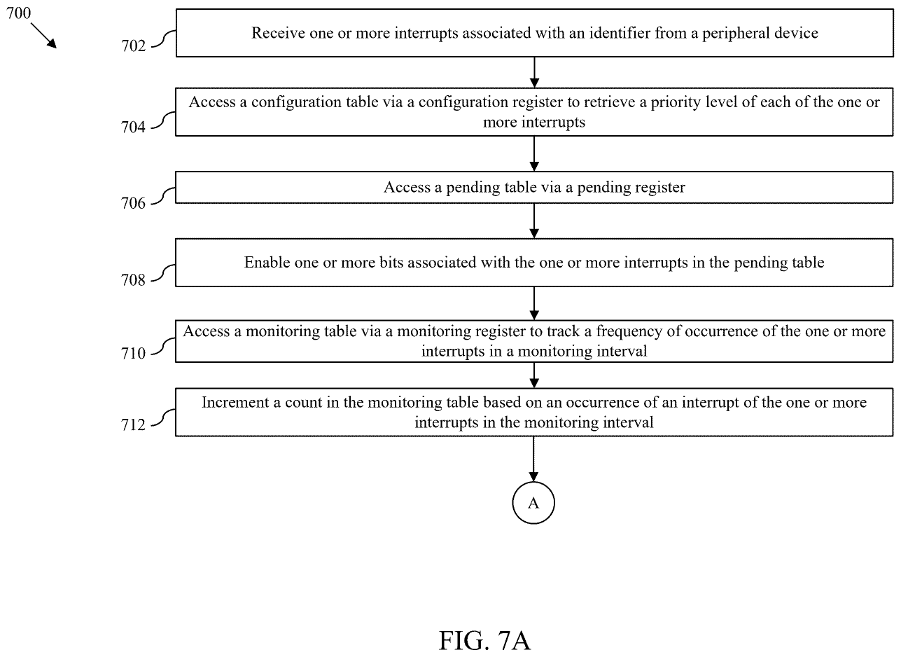

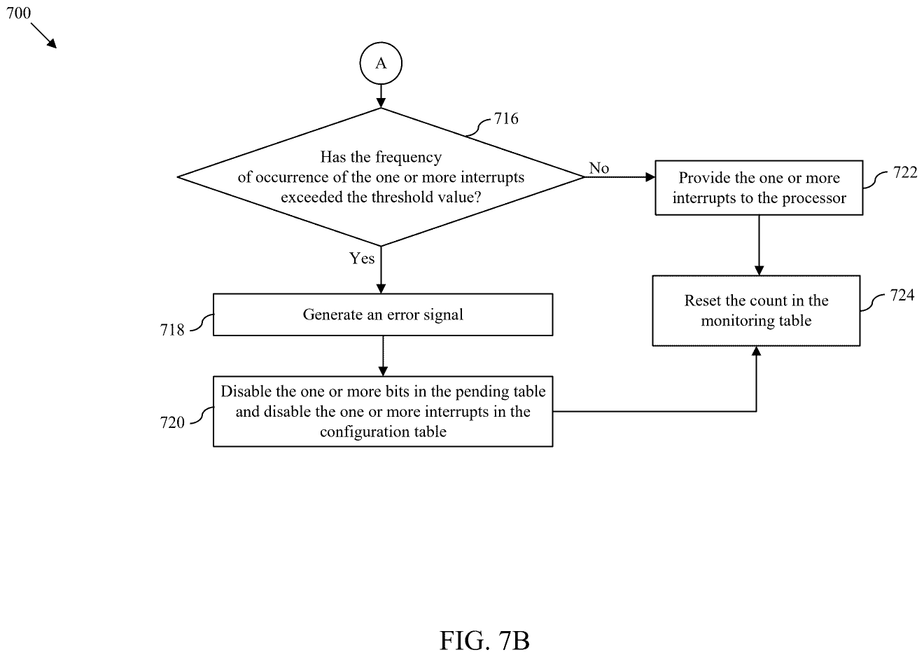

FIGS. 7A and 7B are diagrams that illustrate a detailed flowchart 700 of a method (e.g., a process) executed by the interrupt controller 110, in accordance with an exemplary aspect of the present disclosure. FIGS. 7A and 7B are explained in conjunction with FIG. 1-6.

At 702, one or more interrupts associated with an identifier from a peripheral device may be received. The interrupt handling circuit 118 may receive one or more interrupts (e.g., event identifiers and device identifier) associated with the first peripheral device 102. The interrupt handling circuit 118 may refer to the device table 236 based on the first device identifier, to identify the translation table 238 and translate the event identifiers to one or more interrupt identifiers. Further, the interrupt handling circuit 118 may identify the first monitoring circuit 120a to manage the one or more interrupts based on the collection table 240. Further, the first monitoring circuit 120a may receive the one or more interrupts (e.g., the one or more interrupt identifiers) from the interrupt handling circuit 118 in the monitoring interval.

At 704, a configuration table 242 via a configuration register 216 may be accessed to retrieve a priority level of the one or more interrupts. The configuration table 242 may store a priority level of an interrupt of the one or more interrupts based on each occurrence of the one or more interrupts. The first monitoring circuit 120a may access the configuration table 242 via the configuration register 216 to retrieve the priority level of at least one of the one or more interrupts.

At 706, a pending table 246 via a pending register 220 may be accessed. The first monitoring circuit 120a may access the pending table 246 via the pending register 220 based on the retrieval of each priority level of the one or more interrupts. The pending table 246 may store one or more bits associated with the one or more interrupts.

At 708, one or more bits associated with the one or more interrupts in the pending table 246 may be enabled. The first monitoring circuit 120a may enable one or more bits in the pending table 246 based on the retrieval of the priority level of each interrupt. The enabled one or more bits may be indicative of the status of the one or more interrupts being pending. Further, the one or more bits may remain pending until an end of the monitoring interval.

At 710, a monitoring table 250 via a monitoring register 224 to track a frequency of occurrence of the one or more interrupts may be accessed in a monitoring interval. The first monitoring circuit 120a may access the monitoring table 250 via the monitoring register 224 to track the frequency of occurrence of the one or more interrupts. The monitoring table 250 may be accessed based on the enablement of the one or more bits in the pending table 246.

At 712, a count of the monitoring table 250 based on an occurrence of an interrupt of the one or more interrupts in the monitoring interval may be incremented. The first monitoring circuit 120a may increment the count of the monitoring table 250 based on each reception of the one or more interrupts in the monitoring interval from the interrupt handling circuit 118, to track the frequency of occurrence of the one or more interrupts. In one aspect, the count may be associated with each of the one or more interrupts having a same identifier. In further aspects, the count may be associated with each of the one or more interrupts having at least one of the same identifier or a different identifier.

At 716, it may be determined whether the frequency of occurrence of the one or more interrupts has exceeded the threshold value. The first monitoring circuit 120a may determine whether the frequency of occurrence of the one or more interrupts has exceeded the threshold value based on the count in the monitoring table 250, in the monitoring interval with each reception of the interrupt. At 716, if it may be determined that the frequency of occurrence of the one or more interrupts has exceeded the threshold value, 718 and 720 may be executed. However, at 716, if it may be determined that the frequency of occurrence of the one or more interrupts has not exceeded the threshold value, 722 may be executed.

At 718, an error signal may be generated. The first monitoring circuit 120a may generate the error signal based on the determination that the frequency of occurrence of the one or more interrupts has exceeded the threshold value in the monitoring interval. In one aspect, the count of the one or more interrupts associated with the interrupt identifier may exceed the threshold value. In further aspects, the count of the one or more interrupts associated with the device identifier may exceed the threshold value.

At 720, the one or more bits in the pending table 246 and the one or more interrupts in the configuration table 242 may be disabled. The first monitoring circuit 120a may disable the one or more bits in the pending table 246 based on the determination that the frequency of occurrence of the one or more interrupts has exceeded the threshold value. The frequency of occurrence of the one or more interrupts exceeding the threshold value may be indicative of the first peripheral device 102 being faulty. Further, the first monitoring circuit 120a may disable the one or more interrupts in the configuration table 242 based on the generation of the error signal.

At 722, the one or more interrupts may be provided to the processor. The first monitoring circuit 120a may provide the one or more interrupts to the first processor 114 based on the frequency of occurrence of the one or more interrupts being lower than the threshold value. The first processor 114 may thus initiate the one or more operations associated with the one or more interrupts.

At 724, the count of the monitoring table 250 may be reset. 724 may be executed after 720 and 722. The first monitoring circuit 120a may reset the count in the monitoring table 250 based on one of the generation of the error signal or upon provision of the one or more interrupts to the first processor 114.

Techniques consistent with the present disclosure provide, among other features, systems, and methods for managing peripheral interrupts. Aspects in the present disclosure provide the system 100. A monitoring circuit of the system 100 may track a total frequency of the interrupts (e.g., LPIs) generated by any of the peripheral devices 102-106 based on interrupt identifiers or device identifiers, in the monitoring interval.

The system 100 may provide enhanced security as the frequency of each interrupt may be monitored in the monitoring interval to detect and mitigate malicious activities by defective peripheral devices thereby maintaining integrity and security of the system 100. Further, the stability of the system 100 may be improved as the servicing of excessive interrupts generated erroneously is prevented thereby improving a reliability of the system 100. The resources or memory space of the one or more memories 112 may be managed effectively by tracking and logging the frequencies of the one or more interrupts with minimal overhead on the one or more memories 112 as a single byte may be allocated for each interrupt. As the timer value of the monitoring interval and the threshold value may be configurable, e.g., dynamically adjusted, the system 100 may be capable to adapt to varying interrupt activities of the system 100 and thereby prevent any false positives.

Each interrupt may be tracked in real-time by way of the monitoring table 250 and the monitoring register 224. Corrective actions may be initiated to identify and address the issues associated with defective peripheral devices based on the generation of the error signal. The system 100 may further track simultaneous and continuous interrupts from the peripheral devices 102-106. The SoC 108 may be integrated into all auto chips and IoT devices.

Some implementation examples are described in the following numbered aspects:
Aspect 1: A method executed at an interrupt controller, comprising: tracking, in a monitoring interval, by a monitoring circuit, a frequency of occurrence of one or more interrupts associated with an identifier; and generating by the monitoring circuit, an error signal based on the frequency of occurrence of the one or more interrupts exceeding a threshold value.
Aspect 2: The method of aspect 1, further comprising storing by a monitoring register, an address of a monitoring table.
Aspect 3: The method of aspect 2, further comprising accessing by the monitoring circuit, the monitoring table via the monitoring register to track the frequency of occurrence of the one or more interrupts.
Aspect 4: The method of aspect 3, further comprising: incrementing a count in the monitoring table based on an occurrence of an interrupt of the one or more interrupts in the monitoring interval; determining, in the monitoring interval by the monitoring circuit, based on the count in the monitoring table, whether the frequency of occurrence of the one or more interrupts has exceeded the threshold value; and generating by the monitoring circuit, the error signal based on the determination that the frequency of occurrence of the one or more interrupts has exceeded the threshold value.
Aspect 5: The method of any of aspects 1 to 4, wherein the identifier corresponds to an interrupt identifier that uniquely identifies an interrupt of the one or more interrupts.
Aspect 6: The method of any of aspects 1 to 4, wherein the identifier corresponds to a device identifier that uniquely identifies a peripheral device coupled to the interrupt controller.
Aspect 7: The method of any of aspects 1 to 6, further comprising storing by an interval register, a timer value indicative of the monitoring interval.
Aspect 8: The method of any of aspects 1 to 7, wherein the timer value is configurable.
Aspect 9: The method of any of aspects 1 to 8, further comprising storing by a threshold register, the threshold value.
Aspect 10: The method of any of aspects 1 to 9, wherein the threshold value is configurable.
Aspect 11: The method of any of aspects 1 to 10, further comprising storing by a configuration register, an address of a configuration table.
Aspect 12: The method of aspect 11, further comprising: accessing by the monitoring circuit, the configuration table via the configuration register; and disabling by the monitoring circuit, the one or more interrupts in the accessed configuration table based on the generation of the error signal.
Aspect 13: The method of any of aspects 1 to 12, further comprising storing an address of a pending table by a pending register.
Aspect 14: The method of aspect 13, further comprising accessing by the monitoring circuit, the pending table via the pending register; and disabling by the monitoring circuit, based on the generation of the error signal, one or more bits associated with the one or more interrupts, respectively, in the accessed pending table.
Aspect 15: A method executed at an SoC, comprising: receiving one or more interrupts from one or more peripheral devices by an interrupt handling circuit; tracking by one or more monitoring circuits, in a monitoring interval, a frequency of occurrence of the one or more interrupts associated with an identifier; and generating by the one or more monitoring circuits, an error signal based on the frequency of occurrence of the one or more interrupts exceeding a threshold value.
Aspect 16: The method of aspect 15, further comprising storing by one or more memories, a monitoring table.
Aspect 17: The method of aspect 16, further comprising: incrementing by the one or more monitoring circuits, a count in the monitoring table based on an occurrence of an interrupt of the one or more interrupts in the monitoring interval; determining by the one or more monitoring circuits, in the monitoring interval, based on the count in the monitoring table, whether the frequency of the occurrence of the one or more interrupts has exceeded the threshold value; and generating by the one or more monitoring circuits, the error signal based on the determination that the frequency of occurrence of the one or more interrupts has exceeded the threshold value.
Aspect 18: The method of any of aspects 16 or 17, further comprising storing by a monitoring register, an address of the monitoring table.
Aspect 19: The method of any of aspects 16 through 18, further comprising: accessing by the monitoring circuit, the monitoring table via the monitoring register to track the frequency of occurrence of the one or more interrupts; and resetting by the monitoring circuit, the count in the monitoring table based on the generation of the error signal.
Aspect 20: The method of any of aspects 16 through 19, wherein a size of the monitoring table is based on at least one of: a total number of interrupts associated with the one or more peripheral devices or the threshold value, and wherein the total number of interrupts comprise the one or more interrupts.
Aspect 21: The method of any of aspects 15 through 20, wherein the identifier corresponds to one of: an interrupt identifier that uniquely identifies an interrupt of the one or more interrupts, or a device identifier that uniquely identifies a peripheral device coupled to the interrupt controller.
Aspect 22: The method of any of aspects 15 through 21, further comprising storing by a pending register, an address of a pending table that comprises one or more bits associated with the one or more interrupts, respectively.
Aspect 23: The method of aspect 22, further comprising: accessing by the monitoring circuit, the pending table via the pending register; and disabling, based on the generation of the error signal, the one or more bits associated with the one or more interrupts, respectively, in the accessed pending table.
Aspect 24: The method of any of aspects 15 through 23, further comprising: storing by an interval register, a timer value indicative of the monitoring interval, wherein the timer value is configurable; and storing by a threshold register in the threshold value, wherein the threshold value is configurable.
Aspect 25: The method of any of aspects 15 through 24, further comprising storing by a configuration table, the one or more interrupts associated with the identifier.
Aspect 26: The method of any of aspects 15 through 25, further comprising storing by a configuration register, an address of the configuration table.
Aspect 27: The method of any of aspects 15 through 26, further comprising: accessing the configuration table via the configuration register; and disabling the one or more interrupts in the accessed configuration table based on the generation of the error signal.
Aspect 28: An apparatus comprising: a processor; a memory coupled with the processor; and instructions stored in the memory and executable by the processor to cause the apparatus to perform a method of any of aspects 1 through 14.
Aspect 29: An apparatus for managing interrupts from peripheral devices executed at an interrupt controller, comprising at least one means for performing a method of any of aspects 1 through 14.
Aspect 30: A non-transitory computer-readable medium storing code for managing peripheral interrupts, the code comprising instructions executable by a processor to perform a method of any of aspects 1 through 14.
Aspect 31: An apparatus comprising: a processor; a memory coupled with the processor; and instructions stored in the memory and executable by the processor to cause the apparatus to perform a method of any of aspects 15 through 27.
Aspect 32: An apparatus for managing interrupts from peripheral devices executed at an SoC, comprising at least one means for performing a method of any of aspects 15 through 27.
Aspect 33: A non-transitory computer-readable medium storing code for managing peripheral interrupts, the code comprising instructions executable by a processor to perform a method of any of aspects 15 through 27.

The aforementioned description is provided to enable any person skilled in the art to practice the various aspects described herein. Various modifications to these aspects will be readily apparent to those skilled in the art, and the generic principles defined herein may be applied to further aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more”. As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C).

It is understood that the specific order or hierarchy of steps in the processes disclosed is an illustration of exemplary approaches. Based on design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The aforementioned description is provided to enable any person skilled in the art to practice the various aspects described herein. Various modifications to these aspects will be readily apparent to those skilled in the art, and the generic principles defined herein may be applied to further aspects. All structural and functional equivalents to the elements of the various aspects described throughout this disclosure that are known or later come to be known to those of ordinary skill in the art are expressly incorporated herein by reference and are intended to be encompassed by the claims. No claim element is to be construed as a means plus function unless the element is expressly recited using the phrase “means for.” Further, unless stated otherwise, terms such as “first” and “second” are used to arbitrarily distinguish between the elements such terms describe. Thus, these terms are not necessarily intended to indicate temporal or other prioritization of such elements. The term “coupled” may refer to at least one of direct or indirect coupling that may not necessarily be by way of mechanical or any physical means. Further, a system or method that “comprises”, “has”, or “includes” one or more elements possesses those one or more elements but is not limited to possessing only those one or more elements.

What is claimed is:

1. An interrupt controller, comprising:
a monitoring circuit configured to:
track, in a monitoring interval, a frequency of occurrence of one or more interrupts associated with an identifier; and
generate an error signal based on the frequency of occurrence of the one or more interrupts exceeding a threshold value.

2. The interrupt controller of claim 1, further comprising a monitoring register configured to store an address of a monitoring table, wherein the monitoring circuit is further configured to access the monitoring table via the monitoring register to track the frequency of occurrence of the one or more interrupts.

3. The interrupt controller of claim 2, wherein the monitoring circuit is further configured to:
increment a count in the monitoring table based on an occurrence of an interrupt of the one or more interrupts in the monitoring interval;
determine, in the monitoring interval, based on the count in the monitoring table, whether the frequency of occurrence of the one or more interrupts has exceeded the threshold value; and
generate the error signal based on the determination that the frequency of occurrence of the one or more interrupts has exceeded the threshold value.

4. The interrupt controller of claim 1, wherein
the identifier corresponds to an interrupt identifier that uniquely identifies an interrupt of the one or more interrupts.

5. The interrupt controller of claim 1, wherein the identifier corresponds to a device identifier that uniquely identifies a peripheral device coupled to the interrupt controller.

6. The interrupt controller of claim 1, further comprising an interval register configured to store a timer value indicative of the monitoring interval.

7. The interrupt controller of claim 6, wherein the timer value is configurable.

8. The interrupt controller of claim 1, further comprising a threshold register configured to store the threshold value.

9. The interrupt controller of claim 8, wherein the threshold value is configurable.

10. The interrupt controller of claim 1, further comprising a configuration register configured to store an address of a configuration table, wherein the monitoring circuit is further configured to:
access the configuration table via the configuration register; and
disable the one or more interrupts in the accessed configuration table based on the generation of the error signal.

11. The interrupt controller of claim 1, further comprising a pending register configured to store an address of a pending table, wherein the monitoring circuit is further configured to:
access the pending table via the pending register; and
disable, based on the generation of the error signal, one or more bits associated with the one or more interrupts, respectively, in the accessed pending table.

12. A system-on-chip (SoC), comprising:
one or more memories; and
an interrupt controller coupled to the one or more memories, wherein the interrupt controller comprises:
an interrupt handling circuit configured to receive one or more interrupts from one or more peripheral devices; and
one or more monitoring circuits coupled to the interrupt handling circuit, wherein a monitoring circuit of the one or more monitoring circuits is configured to:
track, in a monitoring interval, a frequency of occurrence of the one or more interrupts associated with an identifier; and
generate an error signal based on the frequency of occurrence of the one or more interrupts exceeding a threshold value.

13. The SoC of claim 12,
wherein the one or more memories are configured to store a monitoring table, and
wherein the monitoring circuit is further configured to:
increment a count in the monitoring table based on an occurrence of an interrupt of the one or more interrupts in the monitoring interval;
determine, in the monitoring interval, based on the count in the monitoring table, whether the frequency of occurrence of the one or more interrupts has exceeded the threshold value; and
generate the error signal based on the determination that the frequency of occurrence of the one or more interrupts has exceeded the threshold value.

14. The SoC of claim 13,
wherein the monitoring circuit comprises a monitoring register configured to store an address of the monitoring table, and
wherein the monitoring circuit is further configured to:
access the monitoring table via the monitoring register to track the frequency of occurrence of the one or more interrupts; and
reset the count in the monitoring table based on the generation of the error signal.

15. The SoC of claim 13, wherein a size of the monitoring table is based on at least one of:
a total number of interrupts associated with the one or more peripheral devices, wherein the total number of interrupts comprise the one or more interrupts, or the threshold value.

16. The SoC of claim 12, wherein the identifier corresponds to one of:
an interrupt identifier that uniquely identifies an interrupt of the one or more interrupts, or
a device identifier that uniquely identifies a peripheral device coupled to the interrupt controller.

17. The SoC of claim 12,
wherein the one or more memories comprise a pending table, wherein the pending table comprises one or more bits associated with the one or more interrupts,
wherein the monitoring circuit further comprises a pending register to store an address of the pending table, and
wherein the monitoring circuit is further configured to:
access the pending table via the pending register; and
disable, based on the generation of the error signal, the one or more bits associated with the one or more interrupts, respectively, in the accessed pending table.

18. The SoC of claim 12, wherein the monitoring circuit comprises:
an interval register configured to store a timer value indicative of the monitoring interval, wherein the timer value is configurable; and
a threshold register configured to store the threshold value, wherein the threshold value is configurable.

19. The SoC of claim 12,
wherein the one or more memories comprise a configuration table configured to store the one or more interrupts associated with the identifier,
wherein the monitoring circuit comprises a configuration register configured to store an address of the configuration table, and
wherein the monitoring circuit is further configured to:
access the configuration table via the configuration register; and
disable the one or more interrupts in the accessed configuration table based on the generation of the error signal.

20. A method executed at an interrupt controller, the method comprising:
tracking, in a monitoring interval, a frequency of occurrence of one or more interrupts associated with an identifier; and
generating an error signal based on the frequency of occurrence of the one or more interrupts exceeding a threshold value.
